(19) United States
(12) Patent Application Publication
(10) Pub. No.: US 2009/0120310 A1
(43) Pub. Date: May 14, 2009

(54) PRINTING SCREENS

(76) Inventors: Avtar Singh Bratch, Weymouth (GB); Lee Edward James Bailey, Weymouth (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/816,681

(22) PCT Filed: Feb. 15, 2006
(86) PCT No.: PCT/GB06/00512

§ 371 Date: May 27, 2008

(30) Foreign Application Priority Data
Feb. 18, 2005 (GB) 0503429.3

(51) Int. Cl. B41C 1/14

(52) U.S. Cl. 101/128.4

(57) ABSTRACT

A printing screen for use in screen printing at least one deposit of a printing medium onto a workpiece, the printing screen comprising: a first, facing sheet which includes at least one printing aperture through which a deposit of a printing medium is to be printed onto a workpiece, and at least one clearance aperture which is configured to receive a feature on the workpiece; and a second, backing sheet which is disposed to a rear surface of the facing sheet, the backing sheet including at least one reservoir aperture which is located in correspondence with the at least one printing aperture in the facing sheet for containing a volume of the printing medium to a rear of the at least one printing aperture in the facing sheet, and at least one blind recess which is located in correspondence with the at least one clearance aperture in the facing sheet such as to define a cavity for enclosing the feature on the workpiece.

The present invention relates to a printing screen, often alternatively referred to as a printing stencil, for use in printing media, in particular a conductive epoxy, onto a workpiece, in particular a leadframe or substrate.

Semiconductor dies are usually attached to leadframes using a conductive epoxy, typically a silver-loaded epoxy, which provides both for electrical contact to the base of the die and good thermal contact between the die and the leadframe. In order to establish such electrical and thermal contact, it is important to ensure that there are no air pockets in the bond between the die and the leadframe, thus requiring all air to be expelled from between the die and the leadframe.

Many techniques are currently employed to deposit conductive epoxy onto leadframes. These techniques include the use of an applicator to pressure-dispense blobs of epoxy onto a leadframe, the use of a stamp to transfer a thin layer of epoxy onto a leadframe, the screen printing of a thin layer of epoxy onto a leadframe using a conventional printing screen, and the screen printing of blobs of epoxy onto a leadframe using a PumpPrint printing screen (PumpPrint is a trade mark of DEK International GmbH, Zurich, Switzerland).

These techniques, whilst effective, do suffer from a number of drawbacks.

Techniques which utilize applicators or stamps are relatively slow, as such applicators and stamps usually only allow for a single deposit of epoxy to be deposited in each operation, and leadframes usually require the attachment of a plurality of dies, thereby requiring repeated operation of the applicators or stamps.

Screen printing using a conventional thin, metal printing screen is capable of depositing a large number of deposits of epoxy in a single printing operation, but it is not possible to use such a conventional printing screen where the leadframe already includes previously-mounted components, as will usually be the case.

Screen printing using a PumpPrint printing screen does allow for printing in the presence of previously-mounted components, but, in order to achieve the very small deposits required, the printing apertures in the PumpPrint printing screen have to be very small, which leads to the problem of blockage of the printing apertures by the conductive, metal flakes in the epoxy, typically silver flakes in a silver-loaded epoxy.

It is thus an aim of the present invention to provide an improved means of depositing deposits of printing media, in particular a loaded epoxy, onto a workpiece, in particular a leadframe or substrate, where the workpiece can include previously-mounted components.

In one aspect the present invention provides a printing screen which allows for deposits of printing media, in particular very small deposits of a loaded epoxy, to be deposited onto a workpiece, in particular a leadframe or substrate.

In another aspect the present invention provides a printing screen for use in screen printing at least one deposit of a printing medium onto a workpiece, the printing screen comprising: a first, facing sheet which includes at least one printing aperture through which a deposit of a printing medium is to be printed onto a workpiece, and at least one clearance aperture which is configured to receive a feature on the workpiece; and a second, backing sheet which is disposed to a rear surface of the facing sheet, the backing sheet including at least one reservoir aperture which is located in correspondence with the at least one printing aperture in the facing sheet for containing a volume of the printing medium to a rear of the at least one printing aperture in the facing sheet, and at least one blind recess which is located in correspondence with the at least one clearance aperture in the facing sheet such as to define a cavity for enclosing the feature on the workpiece.

Preferably, the at least one printing aperture comprises a plurality of slots.

More preferably, the at least one printing aperture comprises a plurality of outer slots which extend outwardly from a central section thereof.

Yet more preferably, the outer slots are elongate slots.

In one embodiment the outer slots have a substantially uniform width.

Preferably, the outer slots flare outwardly relative to one another.

Preferably, the at least one printing aperture comprises an inner slot at the central section thereof.

More preferably, the inner slot is an elongate slot.

In one embodiment the inner slot has a substantially uniform width.

Preferably, the outer slots comprise first and second pairs of outer slots which extend outwardly from respective ones of opposite ends of the inner slot.

More preferably, each of the first and second pairs of outer slots defines a V shape.

In one embodiment the outer slots comprise a third pair of outer slots which extend in substantially opposite directions from substantially a mid-point of the inner slot.

In one embodiment the outer slots comprise a fourth pair of outer slots which extend in substantially opposite directions from respective ones of the opposite ends of the inner slot.

Preferably, the inner and outer slots are separated from one another.

Preferably, the facing sheet has a thickness in the range of from about 25 μm to about 200 μm.

More preferably, the facing sheet has a thickness of about 100 μm.

Preferably, the facing sheet comprises a metal sheet.

Preferably, the at least one reservoir aperture in the backing sheet has a lateral extent just greater than a lateral extent of the at least one printing aperture in the printing sheet.

Preferably, the backing sheet has a thickness in the range of from about 1 mm to about 8 mm.

More preferably, the backing sheet has a thickness of about 3 mm.

Preferably, the facing and backing sheets are bonded together.

More preferably, the facing and backing sheets are bonded together by hot-roll lamination.

Preferably, the facing sheet includes a plurality of printing apertures and the backing sheet includes a plurality of reservoir apertures which are located in correspondence with respective ones of the printing apertures in the facing sheet.

Preferably, the facing sheet includes a plurality of clearance apertures and the backing sheet includes a plurality of blind recesses which are located in correspondence with respective ones of the clearance apertures in the facing sheet.

In one embodiment the printing medium comprises a conductive epoxy.

In a further aspect the present invention provides a printing screen for use in screen printing at least one deposit of a printing medium onto a workpiece, the printing screen comprising: at least one printing region which comprises a sheet which includes a printing aperture through which a deposit of a printing medium is to be printed onto a workpiece, and at least one reservoir which is located to a rear of the printing aperture for containing a volume of the printing medium; and at least one enclosure region which comprises a blind recess which is configured to enclose a feature on the workpiece.

Preferably, the printing screen comprises: a plurality of printing regions.

Preferably, the printing screen comprises: a plurality of enclosure regions.

Preferably, the printing aperture comprises a plurality of slots.

More preferably, the printing aperture comprises a plurality of outer slots which extend outwardly from a central section thereof.

Yet more preferably, the outer slots are elongate slots.

In one embodiment the outer slots have a substantially uniform width.

Preferably, the outer slots flare outwardly relative to one another.

Preferably, the printing aperture comprises an inner slot at the central section thereof.

More preferably, the inner slot is an elongate slot.

In one embodiment the inner slot has a substantially uniform width.

Preferably, the outer slots comprise first and second pairs of outer slots which extend outwardly from respective ones of opposite ends of the inner slot.

More preferably, each of the first and second pairs of outer slots defines a V shape.

In one embodiment the outer slots comprise a third pair of outer slots which extend in substantially opposite directions from substantially a mid-point of the inner slot.

In one embodiment the outer slots comprise a fourth pair of outer slots which extend in substantially opposite directions from respective ones of the opposite ends of the inner slot.

Preferably, the inner and outer slots are separated from one another.

In a still further aspect the present invention provides a printing screen for use in screen printing at least one deposit of a printing medium onto a workpiece, the printing screen comprising a sheet which includes at least one printing aperture through which a deposit of a printing medium is to be printed onto a workpiece, wherein the at least one printing aperture comprises a plurality of outer slots which extend outwardly from a central section thereof.

Preferably, the outer slots are elongate slots.

In one embodiment the outer slots have a substantially uniform width.

Preferably, the outer slots flare outwardly relative to one another.

Preferably, the at least one printing aperture comprises an inner slot at the central section thereof.

More preferably, the inner slot is an elongate slot.

In one embodiment the inner slot has a substantially uniform width.

Preferably, the outer slots comprise first and second pairs of outer slots which extend outwardly from respective ones of opposite ends of the inner slot.

More preferably, each of the first and second pairs of outer slots defines a V shape.

In one embodiment the outer slots comprise a third pair of outer slots which extend in substantially opposite directions from substantially a mid-point of the inner slot.

In one embodiment the outer slots comprise a fourth pair of outer slots which extend in substantially opposite directions from respective ones of the opposite ends of the inner slot.

Preferably, the inner and outer slots are separated from one another.

Preferably, the sheet includes a plurality of printing apertures.

In a yet further aspect the present invention provides a method of manufacturing a workpiece assembly, comprising the steps of: disposing the above-described printing screen at a surface of a workpiece onto which at least one deposit of a printing medium is to be printed; driving a print head over a rear surface of the printing screen to force printing medium into the at least one printing aperture of the printing screen and into contact with an upper surface of the workpiece; and separating the printing screen and the workpiece such as to provide at least one deposit of the printing medium on the workpiece.

Preferably, the method further comprises the step of: pressing at least one object onto the at least one deposit such as to mount the at least one object on the at least one deposit.

In one embodiment the printing medium is a conductive epoxy.

In one embodiment the workpiece is a leadframe or substrate.

Preferred embodiments of the present invention will now be described hereinbelow by way of example only with reference to the accompanying drawings, in which:

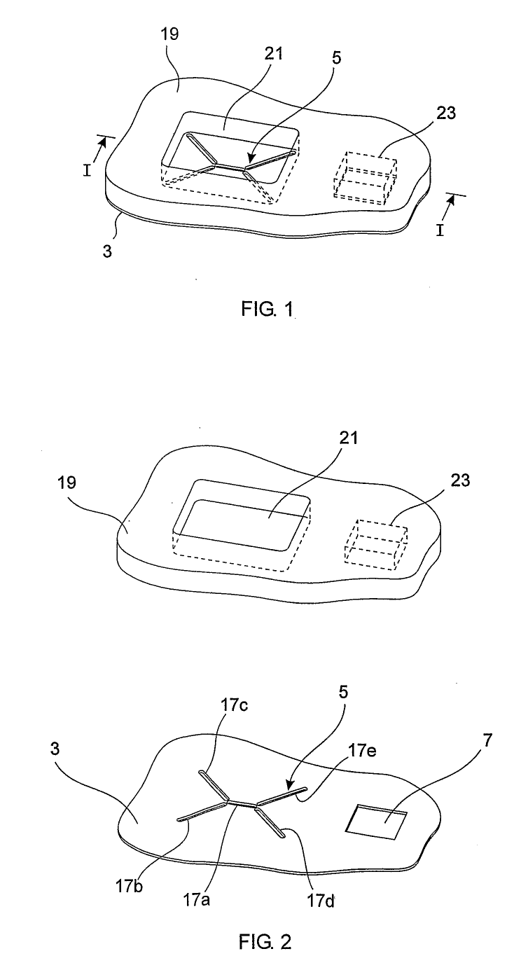

FIG. 1 illustrates a fragmentary perspective view of a printing screen in accordance with a preferred embodiment of the present invention;

FIG. 2 illustrates an exploded perspective view of the printing screen of FIG. 1;

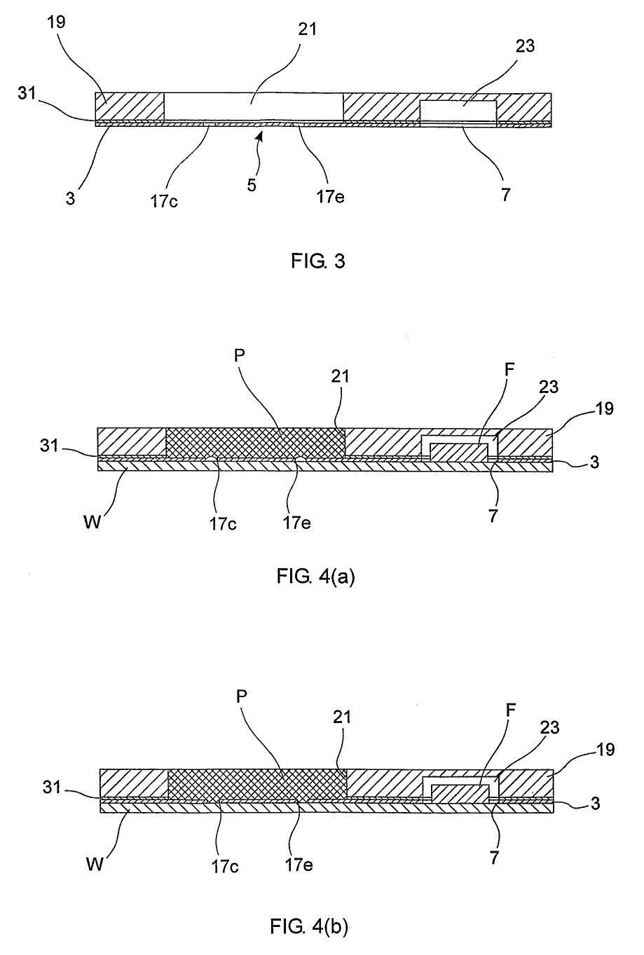

FIG. 3 illustrates a vertical sectional view (section I-I) of the printing screen of FIG. 1;

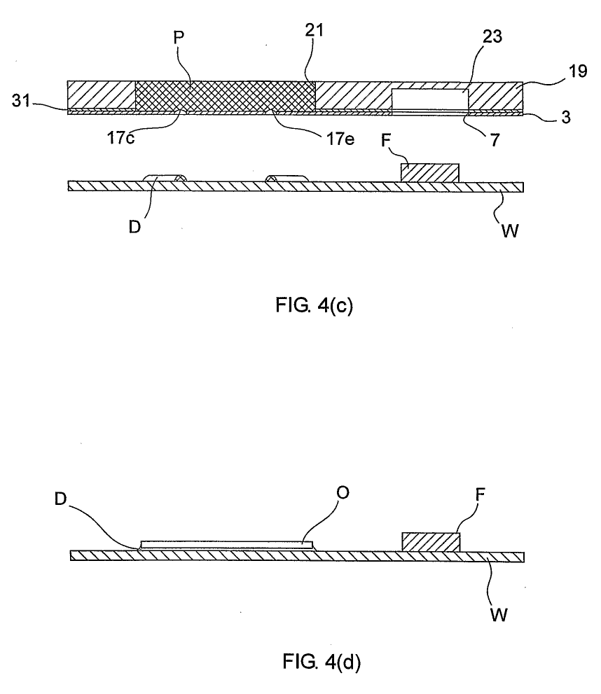

FIG. 4(a) illustrates the printing screen of FIG. 1 where located on a workpiece prior to a printing operation;

FIG. 4(b) illustrates the printing screen of FIG. 1, following operation of the print head of a screen printing machine thereover;

FIG. 4(c) illustrates the printing screen of FIG. 1, following separation from the printed workpiece;

FIG. 4(d) illustrates the printed workpiece of FIG. 4(c) where having an object mounted thereto at the printed deposit;

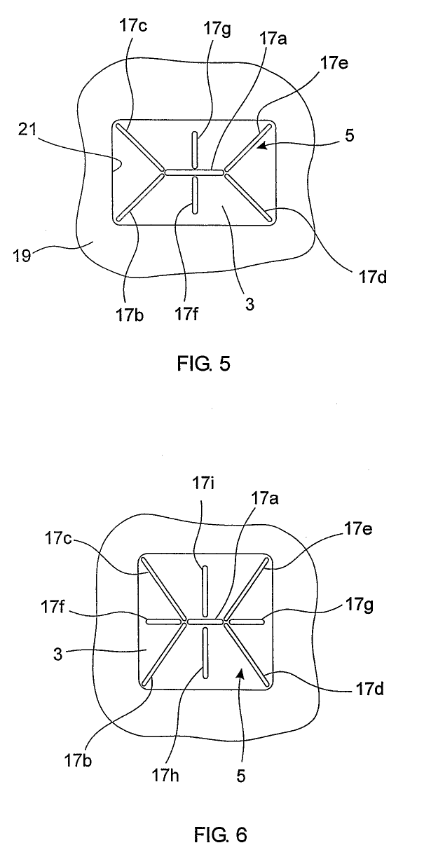

FIG. 5 illustrates a fragmentary plan view of a printing screen as one modification of the printing screen of FIG. 1; and

FIG. 6 illustrates a fragmentary plan view of a printing screen as another modification of the printing screen of FIG. 1.

FIG. 1 illustrates a printing screen in accordance with a preferred embodiment of the present invention.

The printing screen comprises a first, facing sheet 3, in this embodiment a thin, stiff sheet, which includes a plurality of printing apertures 5 through which deposits of a printing medium, in this embodiment a conductive epoxy, are to be printed onto a workpiece, in this embodiment a leadframe or substrate, where the positions of the deposits correspond to the positions of objects, in this embodiment semiconductor dies, which are to be mounted to the workpiece, and a plurality of clearance apertures 7 which are located in correspondence with features, in this embodiment electronic components, which are located on the workpiece. For ease of illustration, only a fragment of the printing screen, which includes one such printing aperture 5 and clearance aperture 7, is illustrated.

In this embodiment the facing sheet 3 comprises a metal sheet, such as a stainless steel sheet, but could be formed of another material, such as a synthetic material, for example, a plastic, where having the necessary rigidity.

In this embodiment the printing and clearance apertures 5, 7 are formed by cutting, here laser cutting, but could be formed by any other known technique, such as chemical etching, or indeed the facing sheet 3 could be formed by electroforming.

In this embodiment the facing sheet 3 has a thickness of about 100 μm. In a preferred embodiment the facing sheet 3 has a thickness in the range of from about 25 μm to about 200 μm.

The printing apertures 5 each comprise a plurality of elongate slots 17a-e which together define the pattern of the deposit which is to be printed on the workpiece, with the printed deposit comprising a plurality of elongate elements in an arrangement corresponding to the slots 17a-e.

In this embodiment the slots 17a-e are each substantially linear, and each have a substantially uniform width. In this embodiment the slots 17a-e have a width of about 100 μm. As will be described in more detail hereinbelow, the width of the slots 17a-e determines the height, and hence amount, of the printed deposit.

In this embodiment the slots 17a-e are separated from one another, such as not to be interconnected. In an alternative embodiment at least ones of the slots 17a-e could be interconnected.

In this embodiment each of the printing apertures 5 comprises five elongate slots 17a-e which are arranged in the form of an extended cross, with a first, central slot 17a defining a central section of the printing aperture 5, and first and second pairs of outer slots 17b, c, 17d, e extending outwardly from the central section. In this embodiment the first and second pairs of outer slots 17b, c, 17d, e extend outwardly from respective ones of the distal ends of the central slot 17a. In simple geometric terms, the slots 17a-e define a shape which can be represented by a Y shape whose tail adjoins the base of a V shape.

In this embodiment the outer slots 17b-e flare outwardly relative to one another, such as to provide that the deposited elements from each of the adjacent ones of the outer slots 17b-e each enclose a space which is of progressively increasing size in an outward direction. With this arrangement, the flow of the printing medium in the outward direction is such as to prevent the entrapment of air pockets.

The printing screen further comprises a second, backing sheet 19, in this embodiment a relatively-thick sheet as compared to the facing sheet 3, which is fixed to the rear surface of the facing sheet 3.

The backing sheet 19 includes a plurality of reservoir apertures 21 which extend through the backing sheet 19 and are located so as to correspond in position to the printing apertures 5 in the facing sheet 3, and a plurality of blind recesses 23 in the lower surface of the backing sheet 19 which are located so as to correspond in position to the clearance apertures 7 in the facing sheet 3. Again, for ease of illustration, only one such reservoir aperture 21 and blind recess 23, which are counterparts to the printing aperture 5 and the clearance aperture 7 in the facing sheet 3, are illustrated.

In this embodiment the backing sheet 19 is formed of a synthetic material, here a plastics material.

In this embodiment the backing sheet 19 has a thickness of about 3 mm. In a preferred embodiment the backing sheet 19 has a thickness in the range of from about 1 mm to about 8 mm.

In this embodiment the reservoir apertures 21, which are here substantially rectangular in shape, have a lateral extent just slightly greater than the lateral extent of the respective printing apertures 5 in the facing sheet 3, and define reservoirs for retaining a volume of a printing medium to the rear of the respective printing apertures 5.

In this embodiment the facing and backing sheets 3, 19 are laminated together using a hot-roll lamination machine, where an “uncured” aqueous polymer is provided between the sheets 3, 19, which polymer, following lamination, is cured and provides a lamination layer 31 which bonds the sheets 3, 19 together. It has been established that this bonding of the facing and backing sheets 3, 19 is able to withstand normal aqueous cleaner tests and the more aggressive hot hydroxide baths.

Use of the printing screen will now be described hereinbelow with reference to FIGS. 4(a) to (d) of the accompanying drawings.

As illustrated in FIG. 4(a), the printing screen is first located over a workpiece W which in this embodiment includes a plurality of features F thereon, in this embodiment electronic components, with the clearance apertures 7 in the facing sheet 3 being located over the respective features F, such as to be enclosed within the blind recesses 23 in the backing sheet 19. For ease of illustration, FIGS. 4(a) to (d) illustrate the workpiece W as including only one such feature F.

As illustrated in FIG. 4(b), a print head of a screen printing machine (not illustrated) is then driven over the upper surface of the printing screen, such as to force printing medium P from the reservoir apertures 21 in the backing sheet 19 into the slots 17a-e of the respective printing apertures 5 and into contact with the upper surface of the workpiece W.

As illustrated in FIG. 4(c), the printing screen and the workpiece W are then separated from one another. As a result of the adhesion force between the workpiece W and the printing medium P at the slots 17a-e of each of the printing apertures 5, in separating the printing screen and the workpiece W, printing medium P at the slots 17a-e of the printing apertures 5 is retained on the workpiece W, such as to provide deposits D on the workpiece W, with each of the deposits D comprising a plurality of elements in an arrangement corresponding to the slots 17a-e of the printing apertures 5. By virtue of the configuration of the printing apertures 5, the printing of very small deposits D can be achieved, with the height, and hence amount, of the deposits D being determined by the width of the slots 17a-e of the printing apertures 5, where slots 17a-e of greater width allow for greater evacuation of the printing medium P in the reservoir apertures 21 in the backing sheet 19.

As illustrated in FIG. 4(d), objects O, in this embodiment semiconductor dies, are then mounted on the workpiece W by pressing the objects O onto the respective deposits D. In pressing an object O downwardly onto the workpiece W, the printing medium P flows in the outward direction, and this flow, by virtue of the configuration of the printed deposit D, is such as to prevent the entrapment of air pockets beneath the workpiece W.

FIG. 5 illustrates a fragmentary view of a printing screen as one modification of the printing screen of the above-described embodiment.

The printing screen of this embodiment differs from that of the printing screen of the above-described embodiment in that the printing apertures 5 in the facing sheet 3 comprise seven elongate slots 17a-g, with a first, central slot 17a defining a central section of the printing aperture 5, and first to third pairs of outer slots 17b, c, 17d, e, 17f, g flaring outwardly from the central section. In this embodiment the first and second pairs of outer slots 17b, c, 17d, e extend outwardly from respective ones of the distal ends of the central slot 17a, and the third pair of outer slots 17f, g extend orthogonally from substantially a mid-point of the central slot 17a. In simple geometric terms, the slots 17a-g define a shape which can be represented by a + shape, and first and second V shapes whose tails adjoin the opposite distal ends of one of the cross members of the + shape.

FIG. 6 illustrates a fragmentary view of a printing screen as another modification of the printing screen of the above-described embodiment.

The printing screen of this embodiment differs from that of the printing screen of the above-described embodiment in that the printing apertures 5 in the facing sheet 3 comprise nine elongate slots 17a-i, with a first, central slot 17a defining a central section of the printing aperture 5, and first to fourth pairs of outer slots 17b, c, 17d, e, 17f, g, 17h, i flaring outwardly from the central section. In this embodiment the first to third pairs of outer slots 17b, c, 17d, e, 17f, g extend outwardly from respective ones of the distal ends of the central slot 17a, and the fourth pair of outer slots 17h, i extend orthogonally from substantially a mid-point of the central slot 17a. In simple geometric terms, the slots 17a-i define a shape which can be represented by a + shape, first and second V shapes whose tails adjoin the opposite distal ends of one of the cross members of the + shape, and first and second I shapes which adjoin the same opposite distal ends of the one of the cross members of the + shape.

Finally, it will be understood that the present invention has been described in relation to its preferred embodiment and can be modified in many different ways without departing from the scope of the invention as defined by the appended claims.

For example, in another embodiment, where printing onto a planar workpiece W, the printing screen could comprise only the facing sheet 3.

Also, use of the embodied printing screen is described in relation to an on-contact printing technique, but in an alternative embodiment the printing screen could be used in an off-contact printing technique.

1. A printing screen for use in screen printing at least one deposit of a printing medium onto a workpiece, the printing screen comprising:
a first, facing sheet which includes at least one printing aperture through which a deposit of a printing medium is to be printed onto a workpiece, wherein the at least one printing aperture comprises a plurality of outer slots which extend outwardly from a central section thereof, such as to define an outwardly-flaring pattern of slots, and at least one clearance aperture which is configured to receive a feature on the workpiece; and
a second, backing sheet which is disposed to a rear surface of the facing sheet, the backing sheet including at least one reservoir aperture which is located in correspondence with the at least one printing aperture in the facing sheet for containing a volume of the printing medium to a rear of the at least one printing aperture in the facing sheet, and at least one blind recess which is located in correspondence with the at least one clearance aperture in the facing sheet such as to define a cavity for enclosing the feature on the workpiece.

2. The printing screen of claim 1, wherein the outer slots are elongate slots.

3. The printing screen of claim 1, wherein the outer slots have a substantially uniform width.

4. The printing screen claim 1, wherein the at least one printing aperture comprises an inner slot at the central section thereof.

5. The printing screen of claim 4, wherein the inner slot is an elongate slot.

6. The printing screen of claim 4, wherein the inner slot has a substantially uniform width.

7. The printing screen of claim 4, wherein the outer slots comprise first and second pairs of outer slots which extend outwardly from respective ones of opposite ends of the inner slot.

8. The printing screen of claim 7, wherein each of the first and second pairs of outer slots defines a V shape.

9. The printing screen of claim 7, wherein the outer slots comprise a third pair of outer slots which extend in substantially opposite directions from substantially a mid-point of the inner slot.

10. The printing screen of claim 9, wherein the outer slots comprise a fourth pair of outer slots which extend in substantially opposite directions from respective ones of the opposite ends of the inner slot.

11. The printing screen claim 4, wherein the inner and outer slots are separated from one another.

12. The printing screen of claim 1, wherein the facing sheet has a thickness in the range of from about 25 μm to about 200 μm.

13. The printing screen of claim 12, wherein the facing sheet has a thickness of about 100 μm.

14. The printing screen of claim 1, wherein the facing sheet comprises a metal sheet.

15. The printing screen of claim 1, wherein the at least one reservoir aperture in the backing sheet has a lateral extent just greater than a lateral extent of the at least one printing aperture in the printing sheet.

16. The printing screen of claim 1, wherein the backing sheet has a thickness in the range of from about 1 mm to about 8 mm.

17. The printing screen of claim 16, wherein the backing sheet has a thickness of about 3 mm.

18. The printing screen of claim 1, wherein the facing and backing sheets are bonded together.

19. The printing screen of claim 18, wherein the facing and backing sheets are bonded together by hot-roll lamination.

20. The printing screen of claim 1, wherein the facing sheet includes a plurality of printing apertures and the backing sheet includes a plurality of reservoir apertures which are located in correspondence with respective ones of the printing apertures in the facing sheet.

21. The printing screen of claim 1, wherein the facing sheet includes a plurality of clearance apertures and the backing sheet includes a plurality of blind recesses which are located in correspondence with respective ones of the clearance apertures in the facing sheet.

22. The printing screen of claim 1, wherein the printing medium comprises a conductive epoxy.

23. A printing screen for use in screen printing at least one deposit of a printing medium onto a workpiece, the printing screen comprising:
at least one printing region which comprises a sheet which includes a printing aperture through which a deposit of a printing medium is to be printed onto a workpiece, wherein the printing aperture comprises a plurality of outer slots which extend outwardly from a central section thereof, such as to define an outwardly-flaring pattern of slots, and at least one reservoir which is located to a rear of the printing aperture for containing a volume of the printing medium; and
at least one enclosure region which comprises a blind recess which is configured to enclose a feature on the workpiece.

24. The printing screen of claim 23, comprising:
a plurality of printing regions.

25. The printing screen of claim 23, comprising:
a plurality of enclosure regions.

26. The printing screen of claim 23, wherein the outer slots are elongate slots.

27. The printing screen of claim 23, wherein the outer slots have a substantially uniform width.

28. The printing screen of claim 23, wherein the printing aperture comprises an inner slot at the central section thereof.

29. The printing screen of claim 28, wherein the inner slot is an elongate slot.

30. The printing screen of claim 28, wherein the inner slot has a substantially uniform width.

31. The printing screen of claim 28, wherein the outer slots comprise first and second pairs of outer slots which extend outwardly from respective ones of opposite ends of the inner slot.

32. The printing screen of claim 31, wherein each of the first and second pairs of outer slots defines a V shape.

33. The printing screen of claim 31, wherein the outer slots comprise a third pair of outer slots which extend in substantially opposite directions from substantially a mid-point of the inner slot.

34. The printing screen of claim 33, wherein the outer slots comprise a fourth pair of outer slots which extend in substantially opposite directions from respective ones of the opposite ends of the inner slot.

35. The printing screen of claim 28, wherein the inner and outer slots are separated from one another.

36. A printing screen for use in screen printing at least one deposit of a printing medium onto a workpiece, the printing screen comprising a sheet which includes at least one printing aperture through which a deposit of a printing medium is to be printed onto a workpiece, wherein the at least one printing aperture comprises a plurality of outer slots which extend outwardly from a central section thereof, such as to define an outwardly-flaring pattern of slots.

37. The printing screen of claim 36, wherein the outer slots are elongate slots.

38. The printing screen of claim 36, wherein the outer slots have a substantially uniform width.

39. The printing screen of claim 36, wherein the at least one printing aperture comprises an inner slot at the central section thereof.

40. The printing screen of claim 39, wherein the inner slot is an elongate slot.

41. The printing screen of claim 39, wherein the inner slot has a substantially uniform width.

42. The printing screen of claim 39, wherein the outer slots comprise first and second pairs of outer slots which extend outwardly from respective ones of opposite ends of the inner slot.

43. The printing screen of claim 42, wherein each of the first and second pairs of outer slots defines a V shape.

44. The printing screen of claim 42, wherein the outer slots comprise a third pair of outer slots which extend in substantially opposite directions from substantially a mid-point of the inner slot.

45. The printing screen of claim 44, wherein the outer slots comprise a fourth pair of outer slots which extend in substantially opposite directions from respective ones of the opposite ends of the inner slot.

46. The printing screen of claim 39, wherein the inner and outer slots are separated from one another.

47. The printing screen of claim 36, wherein the sheet includes a plurality of printing apertures.

48. A method of manufacturing a workpiece assembly, comprising the steps of:
disposing the printing screen of claim 1 at a surface of a workpiece onto which at least one deposit of a printing medium is to be printed;
driving a print head over a rear surface of the printing screen to force printing medium into the at least one printing aperture of the printing screen and into contact with an upper surface of the workpiece; and
separating the printing screen and the workpiece such as to provide at least one deposit of the printing medium on the workpiece, wherein the at least one deposit comprises a plurality of deposited elements which extend outwardly from a central section thereof and define an outwardly-flaring pattern of deposited elements.

49. The method of claim 48, further comprising the step of:
pressing at least one object onto the at least one deposit such as to mount the at least one object on the at least one deposit.

50. The method of claim 48, wherein the printing medium is a conductive epoxy.

51. The method of claim 48, wherein the workpiece is a leadframe or substrate.

52. A method of manufacturing a workpiece assembly, comprising the steps of:
disposing the printing screen of claim 23 at a surface of a workpiece onto which at least one deposit of a printing medium is to be printed;
driving a print head over a rear surface of the printing screen to force printing medium into the at least one printing aperture of the printing screen and into contact with an upper surface of the workpiece; and
separating the printing screen and the workpiece such as to provide at least one deposit of the printing medium on the workpiece, wherein the at least one deposit comprises a plurality of deposited elements which extend outwardly from a central section thereof and define an outwardly-flaring pattern of deposited elements.

53. The method of claim 52, further comprising the step of:
pressing at least one object onto the at least one deposit such as to mount the at least one object on the at least one deposit.

54. The method of claim 52, wherein the printing medium is a conductive epoxy.

55. The method of claim 52, wherein the workpiece is a leadframe or substrate.

56. A method of manufacturing a workpiece assembly, comprising the steps of:
disposing the printing screen of claim 36 at a surface of a workpiece onto which at least one deposit of a printing medium is to be printed;
driving a print head over a rear surface of the printing screen to force printing medium into the at least one printing aperture of the printing screen and into contact with an upper surface of the workpiece; and
separating the printing screen and the workpiece such as to provide at least one deposit of the printing medium on the workpiece, wherein the at least one deposit comprises a plurality of deposited elements which extend outwardly from a central section thereof and define an outwardly-flaring pattern of deposited elements.

57. The method of claim 56, further comprising the step of:
pressing at least one object onto the at least one deposit such as to mount the at least one object on the at least one deposit.

58. The method of claim 56, wherein the printing medium is a conductive epoxy.

59. The method of claim 56, wherein the workpiece is a leadframe or substrate.
